(19) United States
(12) Patent Application Publication
(10) Pub. No.: US 2020/0376518 A1
(43) Pub. Date: Dec. 3, 2020

(54) Apparatus For Applying An Ultraviolet Coating To A Sheet Material

(71) Applicant: Lithographix, Inc., Hawthorne, CA (US)

(72) Inventor: James W. Banninger, JR., Twin Peaks, CA (US)

(73) Assignee: Lithographix, Inc., Hawthorne, CA (US)

(21) Appl. No.: 16/427,189

(22) Filed: May 30, 2019

(51) Int. Cl. B05D 3/06; B01J 19/12

(52) U.S. Cl. CPC B05D 3/062; B05B 12/149; B01J 19/123

(57) ABSTRACT

An apparatus for applying an ultraviolet coating includes: a substantially vertically oriented frame; a first roll rotatably attached to the first side of the frame; a second roll rotatably attached to its second side; multiple nozzles disposed on the first side, above the first roll; a motor coupled to the second roll; an ultraviolet coating fluid reservoir disposed above, and coupled to, the nozzles, thereby providing the nozzles with the ultraviolet coating fluid; and an air compressor coupled to the nozzles, thereby providing the nozzles with compressed air. The ultraviolet coating fluid is provided to the nozzles solely via a gravity feed from the reservoir. In use, the motor causes sheet material, initially wound around the first roll, to advance up and over the frame and then wind onto the second roll, as the ultraviolet coating fluid is sprayed onto the sheet material by the nozzles.

### FIELD OF THE INVENTION

The present invention pertains, among other things, to systems, methods and techniques for spray-coating, e.g., in order to apply an ultraviolet (UV) coating to one or more display banners.

### BACKGROUND

It has long been common for individuals and organizations to hang banners, e.g., for advertising, to provide notices of upcoming events, or to convey any other type of information. Typically, such banners are relatively thin and elongated, most often rectangular in shape.

For durability, particularly when intended for use outdoors, such banners often are made of vinyl, canvas or another kind of cloth, but they may be made of any kind of natural or synthetic sheet material. After printing a banner with the desired content, an ultraviolet coating commonly is applied, in order to prevent or limit fading and other kinds of damage from exposure to sunlight.

Uniformity of such an ultraviolet coating usually is very important. Conventionally, however, the only method that has been able to achieve this goal, especially for large banners, is to first hang the printed banner, spray the ultraviolet coating by hand, and then leave the banner hanging until the coating dries, before finally taking it down. After performing any additional steps (such as sewing the edges, putting in eyelets, etc.) the banner is delivered to the customer.

### SUMMARY OF THE INVENTION

Unfortunately, the present inventor has discovered that the conventional approach of manually applying an ultraviolet coating typically: (1) is overly time-consuming and inefficient, (2) requires a large outdoor area, and (3) can be subject to variances, e.g., depending upon the particular individual who is applying the coating, as well as various factors affecting that individual's performance over time. The present invention addresses these problems, e.g., by providing an apparatus that can apply an ultraviolet coating in an automated and controlled manner, so as to achieve the desired result, both efficiently and on a consistent basis.

Thus, one specific embodiment of the invention is directed to an apparatus for applying an ultraviolet coating that includes: a substantially vertically oriented frame, having a first side, a second side, a bottom and a top; a first roll rotatably attached to the first side of the frame; a second roll rotatably attached to the second side of the frame; multiple nozzles disposed on the first side of the frame, above the first roll; a motor coupled to the second roll; an ultraviolet coating fluid reservoir disposed above, and coupled to, the nozzles, thereby providing the nozzles with the ultraviolet coating fluid; and an air compressor coupled to the nozzles, thereby providing the nozzles with compressed air. In the preferred embodiments, the ultraviolet coating fluid is provided to the nozzles solely via a gravity feed from the fluid reservoir. In use, the motor causes sheet material, initially wound around the first roll, to advance up and over the frame and then wind onto the second roll, as the ultraviolet coating fluid is sprayed onto the sheet material by the nozzles.

By virtue of the foregoing arrangement, it often is possible to overcome many if not all, of the drawbacks noted above in relation to conventional techniques for applying ultraviolet coating material.

The foregoing summary is intended merely to provide a brief description of certain aspects of the invention. A more complete understanding of the invention can be obtained by referring to the claims and the following detailed description of the preferred embodiments in connection with the accompanying figures.

### BRIEF DESCRIPTION OF THE DRAWINGS

In the following disclosure, the invention is described with reference to the accompanying drawings. However, it should be understood that the drawings merely depict certain representative and/or exemplary embodiments and features of the present invention and are not intended to limit the scope of the invention in any manner. The following is a brief description of each of the accompanying drawings.

FIG. 1 is a front-left perspective view of a coating apparatus according to the present invention.

FIG. 2 is a perspective view showing the right side of the coating apparatus.

FIG. 3 is a perspective view showing a portion of the front side of the apparatus, focusing on the apparatus's spraying hardware.

FIG. 4 is a perspective view of the left-side portion of the apparatus's spraying hardware, with the spraying arm adjusted so as to be relatively closer to the sheet material.

FIG. 5 is a perspective view of the left-side portion of the apparatus's spraying hardware, with the spraying arm adjusted so as to be relatively further away from the sheet material.

FIG. 6 is a left side elevational view of the coating apparatus, with the spraying arm adjusted so as to be relatively closer to the sheet material and with optional heaters shown.

FIG. 7 is a left side elevational view of the coating apparatus, with the spraying arm adjusted so as to be relatively further away from the sheet material and with optional heaters shown.

FIG. 8 is a block diagram showing the spraying system of the coating apparatus.

### DESCRIPTION OF THE PREFERRED EMBODIMENT(S)

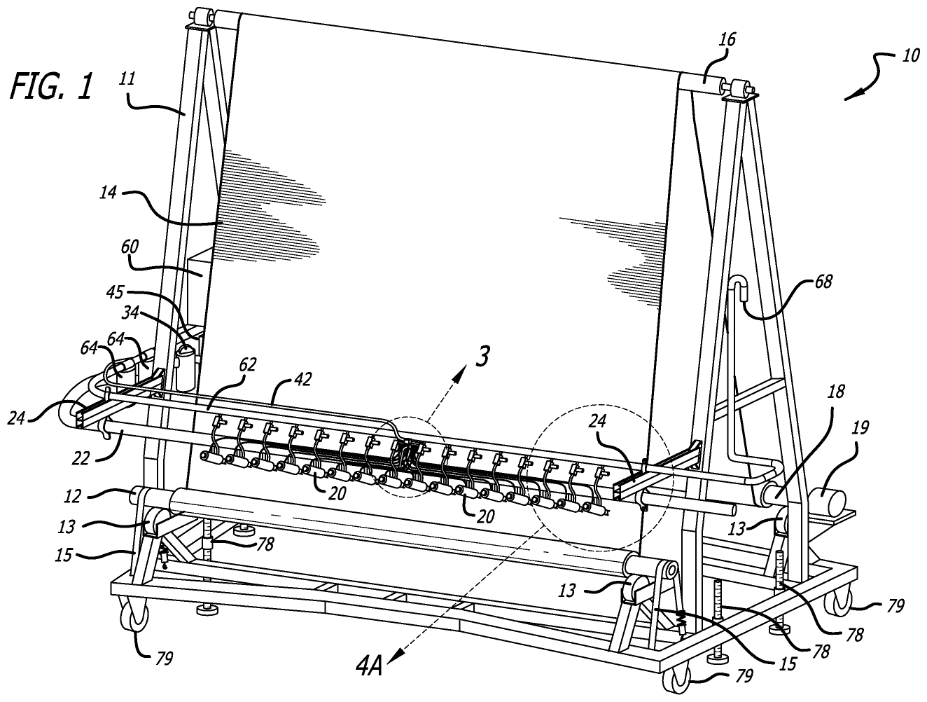

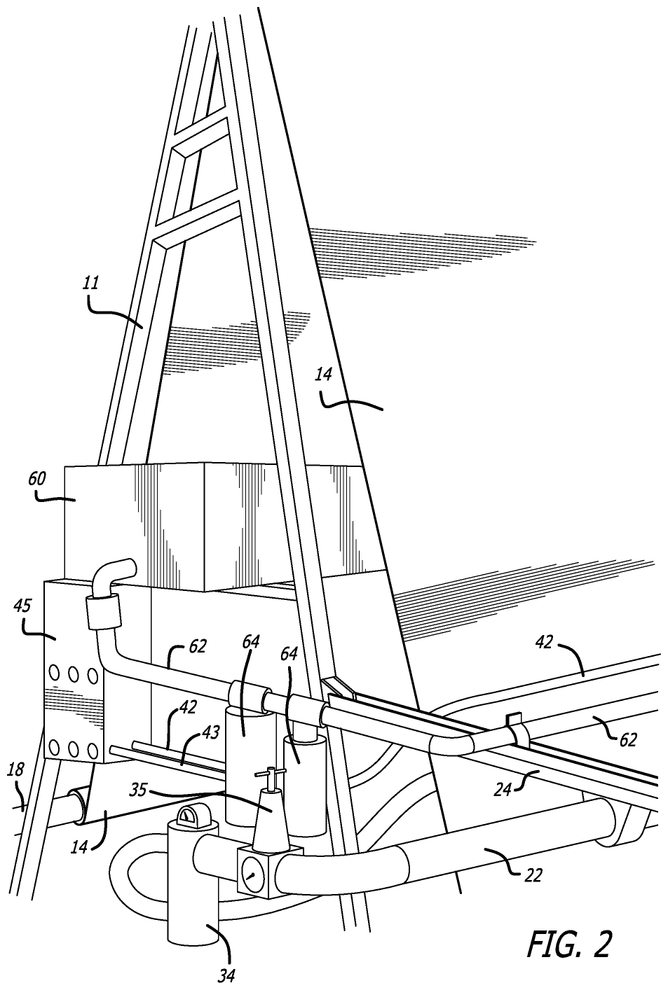

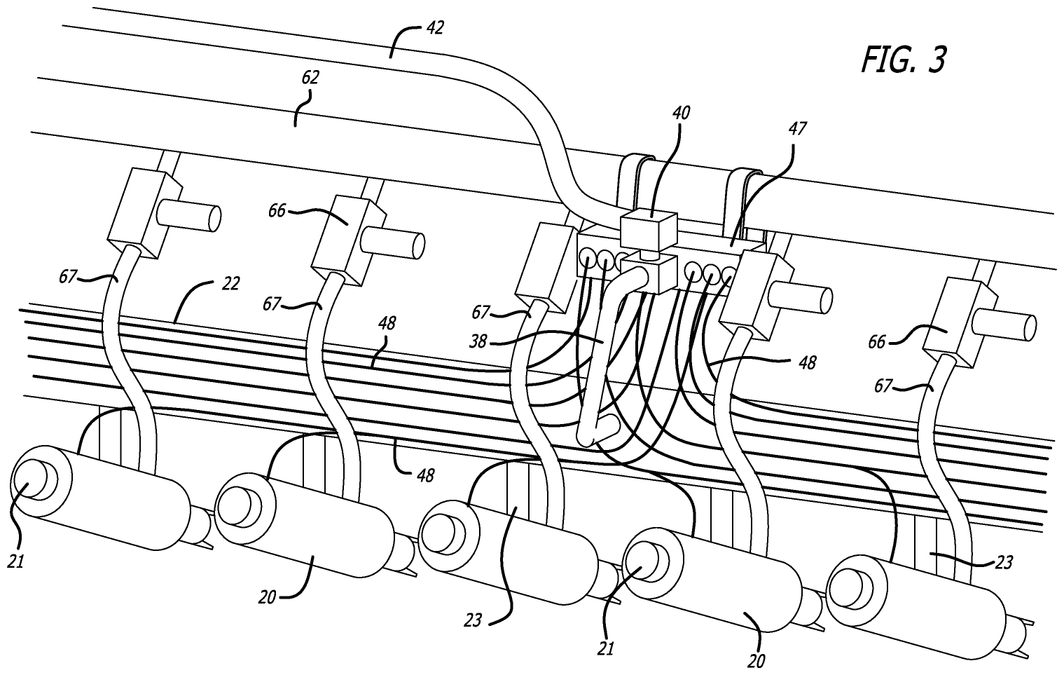

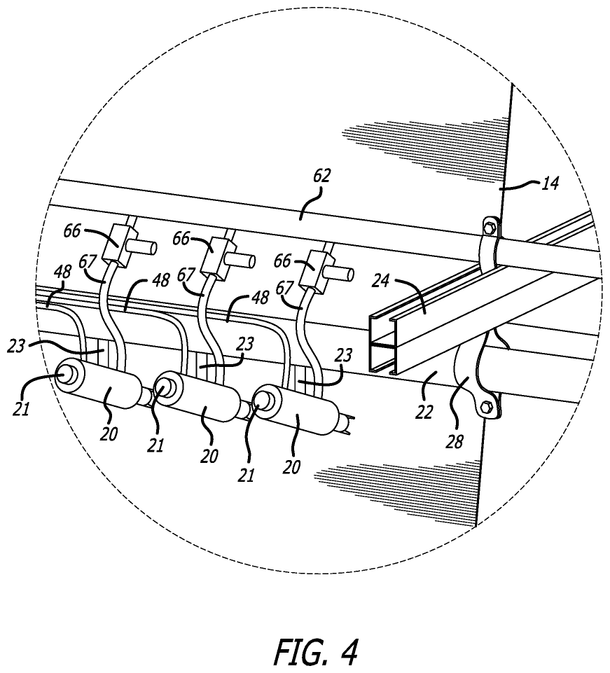

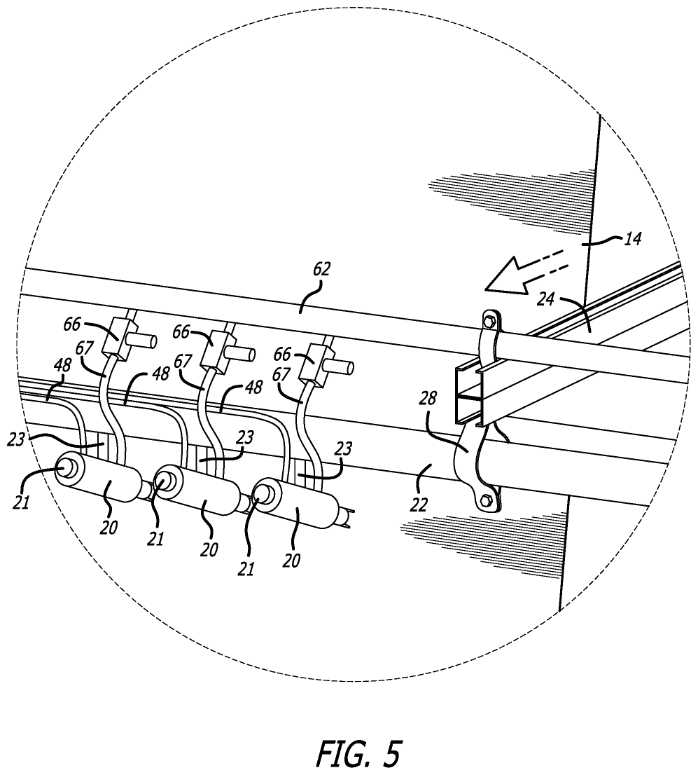

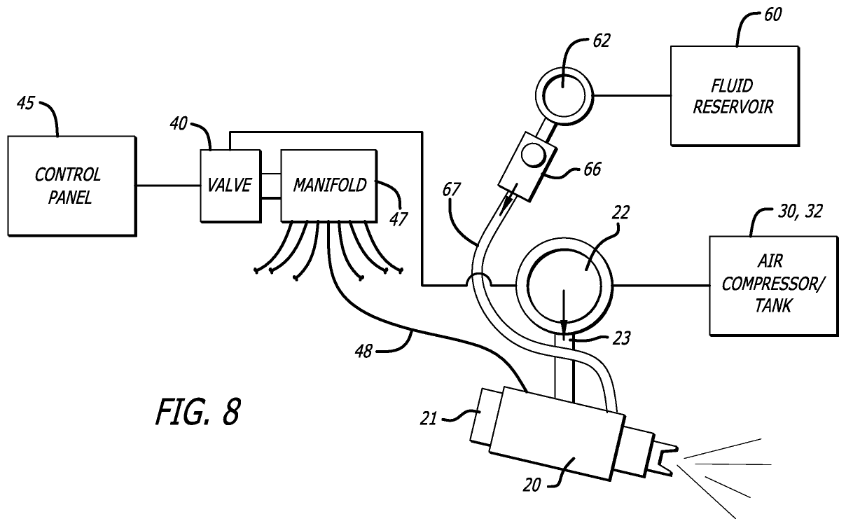

A coating apparatus 10 according to a representative embodiment of the present invention is illustrated in FIGS. 1-8. As shown, in the preferred embodiments, the frame 11 of the apparatus 10 is in the overall shape of an “A” or a triangle, with fairly steep front and rear sides. Generally speaking, such a configuration is inherently stable.

In alternate embodiments, the apparatus 10 has front and rear sides that are entirely, or almost entirely, vertical. Such a configuration can provide even a smaller footprint, but at the cost of less natural stability. Therefore, an apparatus according to such an alternate embodiment (i.e., entirely or almost entirely vertical front and rear sides) preferably also is provided with one or more braces, anchors or other mechanisms for enhancing its stability. Having inherent stability (as opposed to using separate stabilizing mechanisms) is preferred, at least in part, because such a feature allows the entire apparatus 10 to be moved more easily, e.g., as discussed in further detail below.

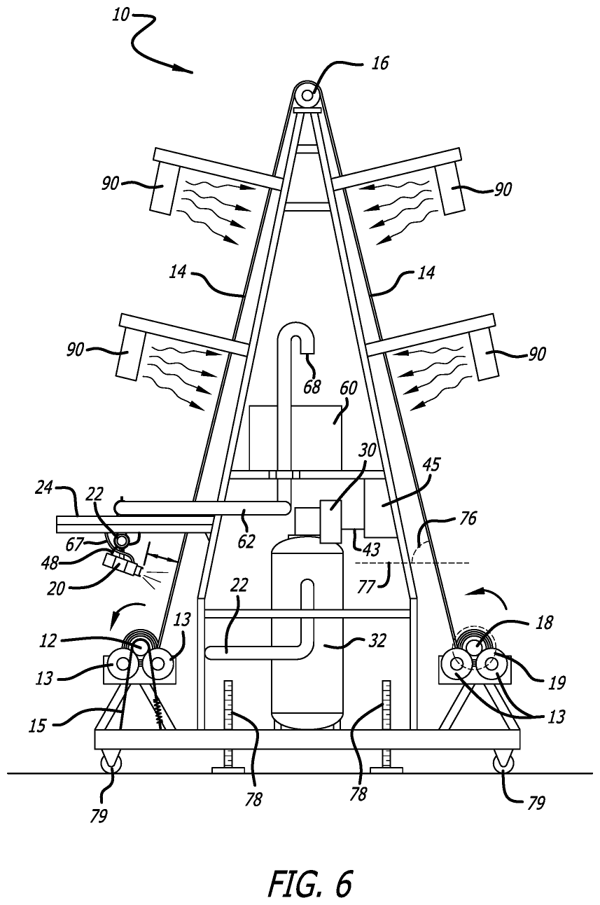

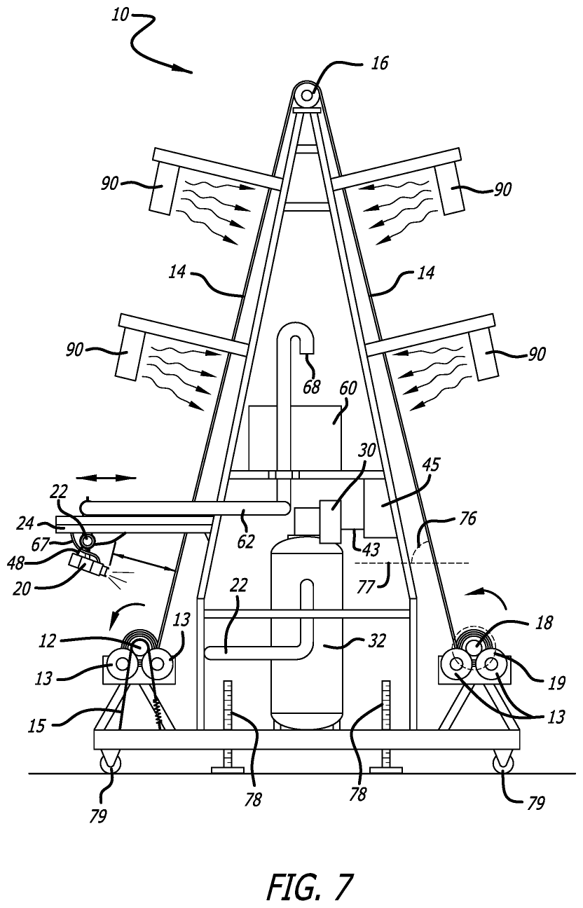

In either such case, by using a substantially vertically oriented configuration (e.g., one that is greater in height than in width), the footprint of the coating apparatus 10 can be kept relatively small. For that reason, an apparatus 10 according to the present invention preferably has at least a significant vertically rising front side and a corresponding significant vertically falling rear side. Preferably, each such side is inclined such that the banner material is at an angle 76 of at least 50, 60 or even 70 degrees relative to a horizontal plane 77 interior to the apparatus 10 (e.g., as shown in FIGS. 6 and 7). At the same time, in order to provide natural stability, the angle 76 is not too great (e.g., less than 75 or 80 degrees relative to the horizontal plane 77 interior to the apparatus 10. Still further alternate embodiments may use a substantially horizontally oriented configuration, at the expense of a larger footprint.

In the present embodiment, preferably near the bottom of the front side of the apparatus 10 is a roll 12 of printed, but currently uncoated, sheet material 14. Typically, such sheet material 14 is made of vinyl, a natural or synthetic fabric (e.g., canvas or another type of cloth), or a nonwoven natural or synthetic material. The front-facing surface of the sheet material 14, as it exits roll 12, preferably already has been printed and is ready to be coated with an ultraviolet coating material. When apparatus 10 is in use, the sheet material 14 originates on roll 12, extends over a top roller 16 and then winds around the rear roll 18. Preferably, both the front roll 12 and the rear roll 18 are near the bottom of the apparatus 10, so as to maximize the travel distance and, therefore, the amount of drying time for the banner sheet material 14 before being rewound onto rear roll 18.

Sheet material 14 preferably includes one or more previously printed display banners (e.g., multiple banners that had been printed continuously but not yet cut into individual banners). A separate strip of material may be temporarily attached to the leading edge of the sheet material 14, and then fed over the top roller 16 and wound around the bottom rear roll 18, prior to starting the apparatus 10. Using such a temporary (typically reusable) strip in this manner can avoid waste of the sheet material 14. However, it also is possible to feed the sheet material 14 itself in this manner prior to turning on the apparatus 10. This latter approach might be acceptable, e.g., when there is a leading portion of the sheet material 14 that does not need to be coated, such as where the initial banner(s), in a continuous roll of currently uncut banners, is/are intended for short-term indoor use (or for any other reason do not require a UV coating). As previously noted, the banner material 14 itself may comprise just a single banner, but more typically will comprise a number of different banners that have been printed continuously onto a single roll of material 14, but not yet cut into separate banners.

In operation, preferably at least rear roll 18 is driven by a motor assembly 19, causing the sheet material 14 to unspool from the front roll 12, advance across the top roller 16, and ultimately re-spool onto rear roll 18. Motor assembly 19 can include, e.g., just a single electric motor or multiple motors (e.g., driving different components of coating apparatus 10 in unison), either alone or in combination with a gear, belt, chain and/or other transmission assembly. In the preferred embodiments, when in use motor assembly 19 causes the sheet material 14 to move through the apparatus 10 (from front roll 12 to rear roll 18) at a rate of approximately 1 inch per second, e.g., 0.8-1.2 or 0.9-1.1 inches per second. Each of the front roll 12 and rear roll 18 typically is just an elongated tube, and each preferably sits between a pair of rollers 13, allowing it to rotate freely.

In the current embodiment, in which the motor assembly 19 is only coupled to the rear roll 18 (i.e., only the rear roll 18 is driven by motor assembly 19), tension is maintained on the front roll 12 through the use of a pair of tension strap assemblies 15. Each tension strap assembly 15 is comprised of a nylon strap in combination with a spring. However, in alternate embodiments any of a variety of other tensioning mechanisms may be used, preferably incorporating either elasticity (e.g., so as to better accommodate tolerances) and/or adjustability (e.g., so as to allow a user to manually change the amount of tension), such as by configuring at least one of the strap assembly 15 attachment points so that it is capable of being moved and then locked into position. In the present embodiment, each strap assembly 15 is attached at each of its ends to the bottom of the frame 11 and loops over the corresponding end of the front roll 12.

At or near the beginning of the path traversed by the sheet material 14, e.g., just above the front roll 12, the front surface of the sheet material 14 passes across a set of fixed-position nozzles 20 (e.g., at least 12, 15 or 17 such nozzles 20, collectively spanning at least 3, 4 or 5 meters in length, so as to coat a sheet material 14 of that with), preferably arranged in a row and mounted to a common substantially horizontal arm 22, which in the current embodiment comprises a metal pipe and also serves as a conduit for providing a pressurized air supply to the nozzles 20.

In the currently preferred embodiment, each of the nozzles 20 is a SATAjet® 1000 ATM RP®. In any event, when pressurized in accordance with the present invention, nozzles 20 preferably emit droplets having a characteristic (e.g., mean or median) size of approximately 5 microns (μm), e.g., a characteristic size of 3-7 μm. Also, in the preferred embodiments, the nozzles 20 are sufficiently separated from each other (e.g., in reference to their distances from the sheet material 14) so that their spray patterns onto the sheet material 14 do not substantially overlap (e.g., no more than 5 or 10 percent overlap).

In the current embodiment, arm 22 is arranged substantially parallel to the surface of the sheet material 14 (e.g., so that each point along its length, as well as the outlet of each nozzle 20, is substantially equidistant from such surface). Also, each of the nozzles 20 preferably is oriented so that the center of its spray pattern is in a direction that is perpendicular, or at least approximately perpendicular, to the surface of the sheet material 14.

In the current embodiment, arm 22 also is capable of sliding along side arms 24 and being locked into place at any desired position, so that the distance between arm 22 (and, consequently, each of the nozzles 20), on one hand, and the surface of sheet material 14, on the other, can be adjusted, and then fixed at a desired distance (e.g., approximately 12 inches, such as 9-15 inches), by the user, e.g., prior to use. However, it should be understood that this feature is optional and, e.g., if a particular fixed distance is desired for all purposes, the arm 22 can be permanently set at that distance from the surface of the sheet material 14.

In addition, in the present embodiment, arm 22 is capable of pivoting or rotating, e.g., upon loosening clamps 28. When the desired orientation is achieved (e.g., such that the centerline of each of the spray patterns is perpendicular or approximately perpendicular to the surface of the sheet material 14), clamps 28 are simply retightened in order to lock arm 22 into that orientation. However, this feature (i.e. the ability to rotate the spray nozzles 20) also is optional and may be omitted in alternate embodiments.

In any event, any such adjustments (e.g., with regard to distance and/or rotational orientation) preferably are performed prior to use. When in use, nozzles 20 preferably are fixed in position and orientation, with only the banner sheet material 14 moving.

One or more air compressors 30, preferably in combination with corresponding pressurized-air storage tanks 32, provide the pressurized air for coating apparatus 10. For simplicity, all of such air compressors and storage tanks sometimes collectively are referred to herein simply as compressor(s) 30. In the current embodiment, two large compressors 30 (e.g., [manufacture/model?]) are used, in order to provide an adequate quantity of airflow. As shown, in the current embodiment such compressor(s) 30 are disposed within the central or interior portion of the apparatus 10. Also, the pressurized air preferably is provided through a common filter 34 (e.g., [manufacture/model?]) and adjustable air-pressure regulator 35 (e.g., [manufacturer/model?]). In use, regulator 35 preferably is set to approximately 45 pounds per square inch (psi), e.g., 40-60 or more preferably 42-48 psi. Electrical cables 43 extend from the control panel 45 to the compressor(s) 30, allowing an operator to turn them on and off from the control panel 45.

As shown, in the current embodiment each of the nozzles 20 is directly coupled to conduit 22 via a pneumatic coupling 23 for receiving its main pressurized air supply for use in its spraying operations. Also, in the current embodiment each of the nozzles 20 is provided with its own airflow controller 21 for controlling the volume of pressurized air flowing through it during such spraying operations.

In addition to directly supplying pressurized air to the nozzles 20 via conduit 22, in the current embodiment the compressor 30 also is coupled to a second input in each of the nozzles 20 for controlling when the corresponding nozzle 20 sprays. Specifically, in the current embodiment that input is coupled to a pneumatically controlled valve within such corresponding nozzle 20 that controls when the nozzle 20 sprays. As shown, conduit 22 is coupled (via a short pipe/conduit 38) to the input of a solenoid valve 40. An electrical cable 42 from the apparatus's master control panel 45 provides electrical power to control the opening and closing of solenoid valve 40. That is, when a switch on control panel 45 is closed, power is provided to solenoid valve 40, thereby opening it and allowing pressurized air flow through it. Such pressurized air, in turn, is then distributed via junction box 47 and individual air hoses 48 to such inputs in the nozzles 20, simultaneously opening all of their corresponding internal pneumatically controlled valves and, therefore, causing all of such nozzles 20 to begin spraying simultaneously. Similarly, when the same switch on control panel 45 subsequently is opened, solenoid valve 40 closes, thereby cutting off air pressure to the pneumatically controlled valves within nozzles 20 and therefore simultaneously turning off all the nozzles 20. Because the pneumatically controlled valves within the nozzles 20 do not require any significant amount of airflow (instead opening and closing based on the existence or absence of pressure), small-diameter hoses 48 typically are sufficient.

The coating material, which is ultraviolet (UV) coating material in the preferred embodiments, initially is stored in reservoir 60. From there, it flows through fluid line 62 (preferably comprising a metal pipe), one or more filters 64, and finally (in the current embodiment) through individual metering valves 66, before flowing into the corresponding individual nozzles 20. In the preferred embodiments, the coating material is provided to the nozzles 20 solely through a gravity feed (e.g., without any pumping or other artificial pressurization). Preferably, fluid line 62 also is coupled to a vent 68 that is disposed above the level of the fluid within reservoir 60 (on the opposite side of the apparatus 10 in the current embodiment), for allowing air trapped within the system to escape, thereby preventing airlock. As shown, in the current embodiment vent 68 is a downwardly facing opening, following a U-shaped bend, which in turn follows an upwardly rising portion of the fluid line 62. This configuration (in which the vent 68 is downwardly facing) can allow air to escape while minimizing the chances of debris entering the system through vent 68.

In order to allow air to escape in this manner, it typically is desirable to maintain the entire apparatus 10 level, or with a slight incline toward the vent 68. For that purpose, apparatus 10 preferably is provided with a plurality of height-adjustment mechanisms 78 (preferably four, two on each side, implemented as screw jacks in the current embodiment) mounted to the frame 11. In addition, the entire frame 11 preferably sits on wheels or casters 79, so that the height-adjustment mechanisms 78 can be shortened to above the level of the casters 79 in order to allow the entire apparatus 10 to be easily moved.

Preferably, coating apparatus 10 is used outdoors, or at least in a well-ventilated environment. The vertically oriented nature of the apparatus 10, in combination with the relatively slow speed at which the sheet material 14 travels, typically will provide adequate time for the coating material to dry before the sheet material 14 is rewound onto rear role 18. However, in some situations, such as where the ambient humidity is high and/or the temperature is low, optional heater(s) 90 (e.g., as shown in FIGS. 6 and 7) are used to direct thermal energy toward the sheet material 14 (e.g., in the form of radiant and/or convection heat). Although not shown, heater(s) 90 preferably receive electrical power through control panel 45, allowing them to be activated (and, in some cases, controlled in terms of the amount of power supplied to them), as needed, using control panel 45.

Prior to using the coating apparatus 10, any or all of the following adjustments are made: (1) the distance between the arm 22 (or, equivalently, the nozzles 20) and the banner material is adjusted and then fixed into position, as described above; (2) the arm 22 is rotated so that the nozzles 20 are oriented perpendicularly (or at another desired angle) to the surface of the banner material and then fixed at that orientation; (3) the entire apparatus is balanced using height-adjustment mechanisms 78; (4) the front roll 12, with the banner sheet material wound around it, is placed into position; (5) a temporary strip attached to the sheet material 14, or the sheet material 14 itself, is extended over the apparatus 10 and initially wound onto, or otherwise attached to, rear roll 18, as discussed above; (6) the compressor(s) 30 are activated from the control panel 45; (7) the air-pressure regulator 35 is adjusted to the desired pressure, as discussed above; (8) the nozzles 20 optionally are temporarily activated so that there sprayed patterns can be adjusted, as desired, using the airflow controllers 21 and the metering valves 66; and (9) the heater(s) 90 are activated and potentially adjusted to achieve the desired thermal output.

Then, to begin operation, the nozzles 20 and the motor assembly 19 are activated from the control panel 45. When the end of the sheet material 14 has passed the nozzles 20, the nozzles 20 are deactivated from the control panel 45, and the sheet material 14 is allowed to continue advancing through the apparatus 10 until it has fully wound onto the rear roll 18. At that point, the motor assembly 19 and the heater(s) 90 (if previously activated) are deactivated through control panel 45.

In alternate embodiments, rear roll 18 is omitted and, instead, the sheet material 14 is provided immediately to another apparatus and/or person for further processing, such as cutting into individual banners, stitching the edges, sewing in eyelets, etc. For that purpose, motor assembly 19 instead, e.g., may be coupled to a pair of rollers or any other mechanism that simply pulls the sheet material 14 through the apparatus 10 and then feeds it to the next operational step.

### ADDITIONAL CONSIDERATIONS

The foregoing discussion mainly focuses on the application of an ultraviolet coating to a sheet material that ultimately is to be used for one or more display banners. However, it should be understood that the systems, apparatuses, methods and techniques described herein generally can be applied to the application of any of a variety of different coating materials to any of a variety of different substrates. Accordingly, in alternate embodiments, (1) where the expression “ultraviolet coating” or similar expressions are used herein, such expressions can be replaced with other types of coatings; and (2) references herein to a banner can be replaced with references to other types of substrates, preferably, relatively thin, flexible and/or sheet-like materials.

As used herein, the term “coupled”, or any other form of the word, is intended to mean either directly connected or connected through one or more other elements. In the drawings and/or the discussions of them, where individual components are shown and/or discussed as being directly connected to each other, such connections should be understood as couplings, which may include additional components.

Unless otherwise clearly stated herein, all relative directions (e.g., left, right, top, bottom, above, below) mentioned herein in relation to an article are from the perspective of the article itself and, therefore, are consistent across different views.

Where a specific value is mentioned herein, such a reference means that value or substantially that value, which includes values that are not substantially different from the stated value, i.e., permitting deviations that would not have substantial impact within the identified context.

In the event of any conflict or inconsistency between the disclosure explicitly set forth herein or in the accompanying drawings, on the one hand, and any materials incorporated by reference herein, on the other, the present disclosure shall take precedence. In the event of any conflict or inconsistency between the disclosures of any applications or patents incorporated by reference herein, the disclosure most recently added or changed shall take precedence.

Unless clearly indicated to the contrary, words such as “optimal”, “optimize”, “maximize”, “minimize”, “best”, as well as similar words and other words and suffixes denoting comparison, in the above discussion are not used in their absolute sense. Instead, such terms ordinarily are intended to be understood in light of any other potential constraints, such as user-specified constraints and objectives, as well as cost and processing or manufacturing constraints.

In the discussion above, functionality sometimes is ascribed to a particular module or component. However, functionality generally may be redistributed as desired among any different modules or components, in some cases completely obviating the need for a particular component or module and/or requiring the addition of new components or modules. The precise distribution of functionality preferably is made according to known engineering tradeoffs, with reference to the specific embodiment of the invention, as will be understood by those skilled in the art.

In the discussions above, the words “include”, “includes”, “including”, and all other forms of the word should not be understood as limiting, but rather any specific items following such words should be understood as being merely exemplary.

Several different embodiments of the present invention are described above and/or in any documents incorporated by reference herein, with each such embodiment described as including certain features. However, it is intended that the features described in connection with the discussion of any single embodiment are not limited to that embodiment but may be included and/or arranged in various combinations in any of the other embodiments as well, as will be understood by those skilled in the art.

Thus, although the present invention has been described in detail with regard to the exemplary embodiments thereof and accompanying drawings, it should be apparent to those skilled in the art that various adaptations and modifications of the present invention may be accomplished without departing from the intent and the scope of the invention. Accordingly, the invention is not limited to the precise embodiments shown in the drawings and described above. Rather, it is intended that all such variations not departing from the intent of the invention are to be considered as within the scope thereof as limited solely by the claims appended hereto.

What is claimed is:

1. An apparatus for applying an ultraviolet coating, comprising:
(a) a substantially vertically oriented frame, having a first side, a second side, a bottom and a top;
(b) a first roll rotatably attached to the first side of said frame;
(c) a second roll rotatably attached to the second side of said frame;
(d) a plurality of nozzles disposed on the first side of said frame, above said first roll;
(e) a motor coupled to said second roll;
(f) an ultraviolet coating fluid reservoir disposed above, and coupled to, said nozzles, thereby providing said nozzles with the ultraviolet coating fluid; and
(g) an air compressor coupled to said nozzles, thereby providing said nozzles with compressed air,
wherein said ultraviolet coating fluid is provided to said nozzles solely via a gravity feed from said reservoir, and
wherein, in use, the motor causes sheet material, initially wound around said first roll, to advance up and over said frame and then wind onto the second roll, as said ultraviolet coating fluid is sprayed onto said sheet material by said nozzles.

2. An apparatus according to claim 1, wherein when extending from the first roll and onto the second roll, the sheet material is sloped at an angle of at least 50 degrees, relative to a horizontal plane interior to said apparatus, on each of the first side and the second side.

3. An apparatus according to claim 1, wherein each of the first roll and the second roll is disposed near the bottom of said frame.

4. An apparatus according to claim 1, wherein an assembly that includes said motor is configured to move the sheet material at a rate of approximately 1 inch per second when said ultraviolet coating fluid is sprayed onto said sheet material by said nozzles.

5. An apparatus according to claim 1, wherein said nozzles are fixed in position and orientation during use.

6. An apparatus according to claim 1, wherein said nozzles include at least 12 individual nozzles.

7. An apparatus according to claim 6, wherein said at least 12 individual nozzles are disposed on a common arm, and wherein a distance between said common arm and a surface of the sheet material can be adjusted and then fixed at a desired length.

8. An apparatus according to claim 6, wherein said at least 12 of said nozzles are disposed on a common arm that can be rotated to adjust an angle of spray of said nozzles and then fixed at a desired angular orientation.

9. An apparatus according to claim 6, wherein said at least 12 individual nozzles are separated from each other by a distance that is sufficient to ensure that their spray patterns do not substantially overlap.

10. An apparatus according to claim 6, wherein said at least 12 individual nozzles are arranged in a substantially straight line and extend across a length of at least 3 meters.

11. An apparatus according to claim 1, further comprising a heater disposed above said nozzles on the first side of said frame and oriented so as to direct thermal energy toward the sheet material.

12. An apparatus according to claim 1, wherein the air compressor also is coupled to a pneumatically operated valve on each of said nozzles through a common solenoid valve, thereby simultaneously turning on said nozzles when the solenoid valve is activated.

13. An apparatus according to claim 1, wherein said ultraviolet coating fluid is coupled from said reservoir to said nozzles via a line that also is coupled to a vent, disposed above said nozzles, for reducing potential airlocks within said line.

14. An apparatus according to claim 1, wherein each of a plurality of said nozzles includes a separate airflow controller.

15. An apparatus according to claim 1, wherein when in use, said nozzles are oriented so as to spray substantially perpendicularly toward a surface of the sheet material.

16. An apparatus according to claim 1, wherein said air compressor is coupled to said nozzles through a common pressure regulator, thereby providing a same air pressure to said nozzles.

17. An apparatus according to claim 1, wherein said nozzles are arranged such that their spray patterns cover, at a surface of the sheet material, a horizontal distance of at least 4 meters without substantial overlap.

18. An apparatus according to claim 1, wherein the ultraviolet coating fluid reservoir is coupled to each of a plurality of said nozzles through a metering valve.
